(19) United States
(12) Patent Application Publication
(10) Pub. No.: US 2025/0004285 A1
(43) Pub. Date: Jan. 2, 2025

(54) PRISM FOR AN OPTICAL SYSTEM

(71) Applicant: Sheltered Wings, Inc. d/b/a Vortex Optics, Barneveld, WI (US)

(72) Inventors: Calen Havens, Barneveld, WI (US); Garrison Bollig, Barneveld, WI (US); William Lowry, Barneveld, WI (US); Alexander Lewis, Barneveld, WI (US)

(21) Appl. No.: 18/756,831

(22) Filed: Jun. 27, 2024

Related U.S. Application Data
(60) Provisional application No. 63/510,743, filed on Jun. 28, 2023.

(51) Int. Cl. G02B 27/01; F41G 3/06; F41G 3/08; G02B 5/04; G02B 23/10

(52) U.S. Cl. CPC G02B 27/0189; G02B 5/04; G02B 23/10; F41G 3/065; F41G 3/08

(57) ABSTRACT

The disclosure relates to viewing optics, and more particularly to a viewing optic having an optical system with a prism and a microdisplay. The optical system can comprise a primary prism and a corrective prism.

### CROSS-REFERENCE TO RELATED APPLICATIONS

This application claims priority to and is a non-provisional patent application of U.S. Provisional Patent Application No. 63/510,743 filed Jun. 28, 2023, which is incorporated herein by reference in its entirety.

### FIELD

The disclosure relates to viewing optics, and more particularly to a viewing optic having an optical system with a prism and a microdisplay.

### BACKGROUND

A large amount of information is needed on a shot-by-shot basis for a shooter to effectively hit a long-range target and the shooter must be able to process this information and make the correct judgments and calculations in real time. In addition to a viewing optic, other tools are needed by the shooter to ensure accurate shot placement. For instance, a bubble level mounted externally to the riflescope is needed to ensure that the optic is level before executing a shot. This requires the shooter to remove his head from the pupil of the optic to check his or her level.

A laser rangefinder and ballistic computer are also needed to measure target range and calculate a bullet trajectory. This once again requires the shooter to attend to an external device and then remember the data when making the necessary adjustments. If a weapon mounted laser rangefinder is used, then the shooter needs to take special care to ensure that the aiming point of the optic is corresponding exactly with the aiming point of the LRF.

Additionally, and not trivial to the use of riflescopes, is that they are most useful during daylight hours. Once night begins to descend, thermal and/or night vision devices typically are attached to the weapon in front of the riflescope. These devices capture other forms of radiation that are not visible to the human eye due to their wavelength or low intensity. These devices then either recreate the image of the scene or intensify it and reimage the scene into the objective of the riflescope. While effective and necessary for low light conditions, these devices are also heavy and large.

In the particular case of thermal imaging devices, a thermal scene is imaged via infrared optics onto a special thermal sensor. The image is then recreated on a microdisplay, and the microdisplay is, in turn, reimaged into the objective of the riflescope with a visible optics system. The two separate optical systems required to accomplish this feat result in a rather large, heavy, and expensive system.

As technology advances, there is a need for some level of system integration to reduce the heavy processing requirements placed on the shooter. This integration is also required to decrease the “time to engagement” that is traditionally quite long when multiple devices are referenced, and calculations and adjustments have to be made. And finally, the size and weight of additional devices needed for effective use of the riflescope in low light conditions can be reduced with a more integrated solution.

Fixed 1× sights, such as red dots and holographic sighting systems, are lighter, less expensive, and allow passive aiming through goggles. However, due to their 1× functionality, they can be limited in their utility. In addition, with a 1× sight, it can be difficult to see targets at a distance and if multiple drops are displayed at the same time, the sight picture can appear very cluttered.

Accordingly, the need exists for a 1× sight with the capabilities and versality offered by a low power viewing optic with a microdisplay.

### SUMMARY

In one embodiment, the disclosure relates to a free form prism. In one embodiment, the disclosure relates to viewing optic having a free form prism.

In one embodiment, the disclosure relates to an optical system having a free form optical prism and a microdisplay, wherein the digital image from the microdisplay is overlayed on an image scene and presented to a user with an extremely forgiving and comfortable eyebox. In one embodiment, the disclosure relates to a viewing optic having a free form prism and a microdisplay. In one embodiment, the viewing optic is a red dot sight or a 1× sight.

In one embodiment, the disclosure relates to an optical system prism that is a doublet made of two prisms. In one embodiment, the disclosure relates to an optical system beam splitter prism that is a doublet made of two prisms.

In another embodiment, the disclosure relates to an optical system prism having a primary prism and a corrective prism. In one embodiment, the optical system also comprises a microdisplay. In one embodiment, the primary prism corrects and directs the light of the image generated from the microdisplay. In another embodiment, the corrective prism corrects, and removes distortion from, and directs the light of, the image from an outward scene. In another embodiment, the corrective prism corrects, and removes distortion from, and directs the image scene light.

In one embodiment, the disclosure relates to a viewing optic with an optical system having a microdisplay, a primary prism and a corrective prism, wherein the viewing optic functions as 1× sight.

In one embodiment, the disclosure relates to a viewing optic comprising: an optical prism system comprising: a primary prism having a first surface, a second surface, a third surface, a fourth surface, and a fifth surface; and a corrective prism, wherein the primary prism and the corrective prism are attached at the fifth surface, the fifth surface having a transmission-controlling coating and a micro display configured to generate an image, wherein light from the image from the microdisplay is split at the fifth surface of the primary prism into a first optical path and a second optical path, wherein light of the first optical path is reflected off the fifth surface of the primary prism to a user's eye, and light of the second optical path travels through the fifth surface of the primary prism. In one embodiment, the optical prism system is a free form optical prism system.

In one embodiment, the second surface of the primary prism has a mirror coating. In another embodiment, the third surface of the primary prism is uncoated. In yet another embodiment, the fourth surface of the primary prism has a mirror coating.

In still another embodiment, the image from the microdisplay enters the primary prism and is corrected at the first surface of the primary prism. In one embodiment, the image from the microdisplay travels from the first surface of the primary prism to the second surface of the primary prism, the second surface having a mirror coating. In another embodiment, the image from the microdisplay travels from the second surface of the primary prism to the third surface of the primary prism, the third surface being uncoated. In yet another embodiment, the image from the microdisplay travels from the third surface of the primary prism to the fourth surface of the primary prism, the fourth surface having a mirror coating. In another embodiment, the image from the microdisplay travels from the fourth surface of the primary prism to the fifth surface of the primary prism.

In another embodiment, light from an outward image scene enters through a first surface of the corrective prism. In another embodiment, the light from the outward image scene passes from the first surface of the corrective prism to the fifth surface of the primary prism. In another embodiment, the light from the outward image scene is split at the fifth surface of the primary prism into a first outward image scene optical path and a second outward image scene optical path, wherein light of the first outward image scene optical path passes through the fifth surface of the primary prism to a user's eye, and light of the second outward image scene optical path is reflected off the fifth surface of the primary prism.

In one embodiment, the first surface of the corrective prism is plano and has an anti-reflective coating.

In another embodiment, the disclosure relates to a viewing optic comprising: an optical prism system comprising: a primary prism; and a corrective prism, wherein the primary prism and the corrective prism are attached at a surface of the primary prism that contains a transmission-controlling coating; and a micro display configured to generate an image, wherein light from the image from the microdisplay is split at the surface of the primary prism into a first optical path and a second optical path, wherein light of the first optical path is reflected off the surface of the primary prism to a user's eye, and light of the second optical path travels through the surface of the primary prism. In one embodiment, the primary prism comprises at least one surface coated with a mirror coating. In another embodiment, the primary prism comprises at least one uncoated surface where the image undergoes total internal reflection.

In one embodiment, the disclosure relates to a system comprising a viewing optic with an optical system disclosed herein and an enabler coupled to the viewing optic. In one embodiment, the enabler is selected from the group consisting of: a laser range finder (LRFs), an imaging enabler a ballistic calculator, a thermal camera, a day camera, a night vision camera, a wind reader, a stabilizer, a compass, an aiming laser module, a battery pack, and an illuminator.

In still another embodiment, the disclosure relates to a system comprising a viewing optic with an optical system disclosed herein and a magnifier. In one embodiment, the magnifier is configured to have a first configuration and a second configuration, the first configuration being located behind the viewing optic and the second configuration being to a side of the viewing optic. In yet another embodiment, the system comprises a detection system to sense the configuration of the magnifier. In one embodiment, the microdisplay of the viewing optic generates a first reticle when the detection system senses the magnifier is in the first configuration and generates a second reticle when the detection system senses the magnifier is in the second configuration.

In yet another embodiment, the disclosure relates to a riflescope having a body, an objective assembly coupled to a first end of the body, an ocular assembly coupled to the second end of the body and the viewing optic with an optical system disclosed herein, wherein the viewing optic is a red dot sight and coupled to the objective assembly of the riflescope.

In one embodiment, the disclosure relates to a method of displaying an image comprising: viewing an image of an outward scene with a viewing optic, the viewing optic comprising an optical prism system having a primary prism and a corrective prism and a microdisplay, wherein the primary prism and the corrective prism are attached at a surface of the primary prism that contains a transmission-controlling coating; generating an image with the microdisplay; and passing the image from the microdisplay to the primary prism, wherein the image from the microdisplay is split at the surface of the primary prism of the viewing optic into a first optical path and a second optical path, wherein light of the first optical path is reflected off the surface of the primary prism to a user's eye, and light of the second optical path travels through the surface of the primary prism.

In another embodiment, the method comprises passing light from an outward image scene through a first surface of the corrective prism. In another embodiment, the method comprises passing light from the outward image scene from the first surface of the corrective prism to the surface of the primary prism. In still another embodiment, the method comprises splitting light from the outward image scene at the surface of the primary prism into a first outward image scene optical path and a second outward image scene optical path, wherein light of the first outward image scene optical path passes through the surface of the primary prism to a user's eye, and light of the second outward image scene optical path is reflected off the surface of the primary prism.

In one embodiment, the disclosure relates to a system comprising a viewing optic with an optical system having a microdisplay, a primary prism and a corrective prism, and a magnifier, wherein the viewing optic is placed in front of the magnifier in relation to the view of the user (from the perspective of the user of the device).

In one embodiment, the disclosure relates to a system comprising: a riflescope having a body, an objective assembly coupled to a first end of the body configured to focus a target image from an outward scene to a first focal plane, an ocular assembly coupled to the second end of the body; an erector lens system, and a second focal plane; and a red dot sight comprising a doublet prism comprising a primary prism and a corrective prism and a microdisplay configured to generate an image, the red dot sight configured to couple to the objective assembly of the riflescope.

In one embodiment, the disclosure relates to a system comprising: a riflescope having a body, an objective assembly coupled to a first end of the body configured to focus a target image from an outward scene to a first focal plane, an ocular assembly coupled to the second end of the body; an erector lens system, and a second focal plane; and a viewing optic comprising a doublet prism comprising a primary prism and a corrective prism and a microdisplay configured to generate an image, the viewing optic configured to couple to the objective assembly of the riflescope.

In one embodiment, the disclosure relates to a system comprising: a viewing optic having a body, a doublet prism comprising a primary prism and a corrective prism and a microdisplay configured to generate an image; and an imaging enabler coupled to the body of the viewing optic.

In one embodiment, the disclosure relates to a system comprising: a viewing optic having a body, a doublet prism comprising a primary prism and a corrective prism and a microdisplay configured to generate an image; and an imaging enabler located in front of or behind the viewing optic.

In another embodiment, the disclosure relates to a system comprising: a viewing optic having a body, a doublet prism comprising a primary prism and a corrective prism and a microdisplay configured to generate an image; and an enabler coupled to the body of the viewing optic. In one embodiment, the enabler is selected from the group consisting of: a laser range finder (LRFs), a ballistic calculator, a thermal camera, a day camera, a night vision camera, a wind reader, a stabilizer, a compass, an aiming laser module, a battery pack, and an illuminator,

In another embodiment, the disclosure relates to a system comprising: a viewing optic having a body, a doublet prism comprising a primary prism and a corrective prism and a microdisplay configured to generate an image; and a magnifier located behind the viewing optic as perceived by a user looking through the magnifier.

In another embodiment, the disclosure relates to a viewing optic comprising: a body, a doublet prism comprising a primary prism and a corrective prism, a microdisplay configured to generate a digital reticle, and a sensor for detecting the presence of a magnifier, wherein the microdisplay generates a first digital reticle when the magnifier is not detected and a second digital reticle when the magnifier is detected.

In another embodiment, the disclosure relates to a system comprising: a viewing optic having a body, a doublet prism comprising a primary prism and a corrective prism and a microdisplay configured to generate a digital reticle; and a magnifier having a first configuration located behind the viewing optic and a second configuration located to the side of the viewing optic, wherein the viewing optic has a sensor for detecting the first configuration and further wherein the microdisplay generates a first digital reticle when the magnifier is in the first configuration and a second digital reticle when the magnifier is in the second configuration.

In another embodiment, the disclosure relates to a system comprising: a viewing optic having a body, a doublet prism comprising a primary prism and a corrective prism and a microdisplay configured to generate an image; and a laser rangefinder coupled to the body of the viewing optic.

In one embodiment, the disclosure relates to a system comprising a viewing optic with an optical system having a microdisplay, a primary prism and a corrective prism, and a riflescope, wherein the viewing optic is placed in front of the riflescope with regard to the directional perspective of the user of the viewing optic.

In one embodiment, the disclosure relates to a system comprising a viewing optic with an optical system having a microdisplay, a primary prism and a corrective prism, and an imaging enabler wherein the viewing optic is placed in front of the imaging enabler with regard to the directional perspective of the user of the viewing optic (the viewing optic is farther away from the eye of the user as compared to the imaging enabler).

In one embodiment, the disclosure relates to a system comprising a viewing optic with an optical system having a microdisplay, a primary prism and a corrective prism, and an imaging enabler wherein the viewing optic is placed behind the imaging enabler with regard to the directional perspective of the user of the viewing optic (the viewing optic is closer to the eye of the user as compared to the imaging enabler).

One advantage of the disclosure is that the use of a prism minimizes the number of optical elements required and creates a bigger exit pupil as compared to other sights with similar capabilities.

One advantage of the disclosure is that while the prism has a two-part design, the free form prism's image creating optical surfaces are all created in a single molded optical element.

One advantage of the disclosure provided herein is that the viewing optic has infinite eye relief and can achieve a much larger field of view and exit pupil than other competitors who use parabolic mirrors to generate their digital reticles within a sight picture.

One advantage of the disclosure provided herein is that the optical design, and construction allows the viewing optic to be nearly any size, while maintaining consistent optical performance and salient design characteristics, with minimal weight impact.

Some of the advantages of the viewing optic disclosed herein are the performance, cost, durability, size, weight and most importantly, the incredible versability offered by the viewing optic. The embodiments that follow offer examples of integration, but the viewing optic could take many form factors. The optical system disclosed herein can be incorporated into a standalone 1× optic, have magnification, be incorporated into a magnified prism optic, be incorporated into the front of a traditional optic, or used in conjunction with magnifiers, separate traditional riflescopes, and/or imaging optics.

Many of the Figures herein display the viewing optic on a rifle, but the viewing optic can be mounted to any relevant projectile launcher, including, but not limited to firearms, bows, crossbows, air guns, spring powered devices, and sling shots. Likewise, the viewing optic can have applications beyond that of a weapon sighting system. The viewing optic may also be used as a handheld device if appropriate or be used in conjunction with other optical devices including, but not limited to, riflescopes, red dots, thermal sights, night vision goggles, spotting scopes, binoculars, monoculars, telescopes, and cameras.

The viewing optic disclosed herein can be mounted to/on any of these devices via picatinny rails, optics rails, optics mounts, proprietary optics plates or mounts, or via any other effective way of mounting. Likewise, the viewing optic disclosed herein may use any number or style of clamps, screws, or other hardware to secure itself. The viewing optic may also be integral with a weapon, optic, or another relevant device. The viewing optic may use/adhere to existing optical, accessory, or hardware footprints/standards to attach to relevant devices/equipment.

The optical system of the viewing optic disclosed herein can display a single or multiple point/s of aim, ballistic corrections, headings, inclinations, video feeds, target reference points (TRPs) augmented reality data, training information, or any other information relevant to the user. Information can be alpha numeric and/or displayed as symbols, graphics, or any other relevant format. Ballistics corrections could be calculated with the viewing optic disclosed herein, or the ballistics could be generated on an enabler and be sent to the viewing optic to be displayed for the user.

### BRIEF DESCRIPTION OF THE DRAWINGS

Embodiments of the disclosure are disclosed with reference to the accompanying drawings and are for illustrative purposes only. The disclosure is not limited in its application to the details of construction, or the arrangement of the components illustrated in the drawings. The disclosure is capable of other embodiments or of being practiced or carried out in other various ways. Like reference numerals are used to indicate like components. In the drawings:

FIG. 1 is a representative non-limiting embodiment of a doublet prism having a primary prism and a corrective prism disclosed herein;

FIG. 2 is a representative non-limiting embodiment of a path for the generated image from the microdisplay disclosed herein;

FIG. 3 is a representative non-limiting embodiment of a path for the image of the outward scene disclosed herein;

FIG. 4 is a representative non-limiting embodiment of a viewing optic with an optical system on a riflescope as disclosed herein;

FIG. 5 is a representative non-limiting embodiment of an outward image scene as observed by a user without the use of a viewing optic;

FIG. 6 is a representative non-limiting embodiment of an outward image scene as observed by a user with the use of a viewing optic having an optical system with a prism as disclosed herein;

FIG. 7 is a representative non-limiting embodiment of a viewing optic having an optical system with a prism and magnification capabilities on a firearm as disclosed herein;

FIG. 8 is a representative non-limiting embodiment of a viewing optic having an optical system with a prism and coupled to a laser rangefinder with a magnifier located behind the viewing optic in relation to the view of the user of the optic as disclosed herein;

FIG. 9 is a representative non-limiting embodiment of an outward image scene as observed by a user looking through a viewing optic having an optical system with a prism and coupled to a laser rangefinder with a magnifier located behind the viewing optic in relation to the view of the user of the optic as disclosed herein;

FIG. 10 is a representative non-limiting embodiment of a viewing optic having an optical system with a prism and coupled to an imaging enabler as disclosed herein;

FIG. 11 is a representative non-limiting embodiment of an outward image scene as observed by a user looking through a viewing optic having an optical system with a prism and coupled to an imaging enabler as disclosed herein;

FIG. 12 is a representative non-limiting embodiment of a viewing optic having an optical system with a prism and coupled to an imaging enabler located either in front of the viewing optic and/or in back of the viewing optic in relation to the view of the user looking through the viewing optic as disclosed herein;

FIG. 13 is a representative non-limiting embodiment of a viewing optic having an optical system with a prism and coupled to a handgun as disclosed herein;

FIG. 14 is a representative non-limiting embodiment of a viewing optic having an optical system with a prism and coupled to a machine gun as disclosed herein;

FIG. 15 is a representative non-limiting embodiment of a viewing optic having an optical system with a prism and coupled to an objective lens of a riflescope as disclosed herein;

FIG. 16 is a representative non-limiting embodiment of an image scene viewed through a traditional magnified riflescope set to 1× as disclosed herein;

FIG. 17 is a representative non-limiting embodiment of an image scene viewed through a traditional magnified riflescope set to 1× with a viewing optic having an optical system with a prism in front of the riflescope as disclosed herein;

FIG. 18 is a representative non-limiting embodiment of an image scene viewed through a traditional magnified riflescope set to 1× with a viewing optic having an optical system with a prism in front of the riflescope, wherein the viewing optic projects a large digital reticle for easy acquisition as disclosed herein;

FIG. 19 is a representative non-limiting embodiment of an image scene viewed through a traditional magnified riflescope set to 1× with a viewing optic having an optical system with a prism in front of the riflescope, wherein the viewing optic projects a ballistically corrected aim point as disclosed herein;

FIG. 20 is a representative non-limiting embodiment of an image scene viewed through a traditional magnified riflescope set at a magnification beyond 1× with a viewing optic having an optical system with a prism in front of the riflescope, wherein the viewing optic projects a ballistically corrected aim point as disclosed herein;

FIG. 21 is a representative non-limiting embodiment of a viewing optic having an additional corrective optical assembly;

FIG. 22 is a representative non-limiting embodiment of a viewing optic with an optical system as disclosed herein and a traditional magnified viewing optic;

FIG. 23 is a representative non-limiting embodiment of a viewing optic as disclosed herein attached to a separate wireless laser rangefinder and attached to a traditional magnified rifle scope;

FIG. 24 is a representative non-limiting embodiment of a viewing optic as disclosed herein integrated into the front of a long-range high magnification riflescope;

FIG. 25 is a representative non-limiting embodiment of a magnifier on a flip mount flipped to side and out of the way of the viewing optic with an optical system disclosed herein.

Before explaining embodiments of the disclosure in detail, it is to be understood that the disclosure is not limited in its application to the details of construction and the arrangement of the components set forth in the following description or illustrated in the drawings. The technology of this disclosure is capable of other embodiments or being practiced or carried out in various ways. Also, it is to be understood that the phraseology and terminology employed herein is for the purpose of description and should not be regarded as limiting.

### DETAILED DESCRIPTION

The disclosure relates to covers for viewing optics and related devices. Certain preferred and illustrative embodiments of the invention are described below. The present invention is not limited to these embodiments.

The apparatuses and methods disclosed herein will now be described more fully hereinafter with reference to the accompanying drawings, in which embodiments of the disclosure are shown. The apparatuses and methods disclosed herein may, however, be embodied in many different forms and should not be construed as limited to the embodiments set forth herein. Rather, these embodiments are provided so that the disclosure will be thorough and complete and will fully convey the scope of the invention to those skilled in the art.

It will be appreciated by those skilled in the art that the set of features and/or capabilities may be readily adapted within the context of a standalone weapons sight, front-mount or rear-mount clip-on weapons sight, and other permutations of filed deployed optical weapons sights. Further, it will be appreciated by those skilled in the art that various combinations of features and capabilities may be incorporated into add-on modules for retrofitting existing fixed or variable weapons sights of any variety.

It will be understood that when an element or layer is referred to as being “on”, “connected to” or “coupled to” another element or layer, it can be directly on, connected or coupled to the other element or layer. Alternatively, intervening elements or layers may be present. In contrast, when an element is referred to as being “directly on,” “directly connected to” or “directly coupled to” another element or layer, there are no intervening elements or layers present.

Like numbers refer to like elements throughout. As used herein, the term “and/or” includes any and all combinations of one or more of the associated listed items.

It will be understood that, although the terms first, second, etc. may be used herein to describe various elements, components, regions, and/or sections, these elements, components, regions, and/or sections should not be limited by these terms. These terms are only used to distinguish one element, component, region, or section from another element, component, region, or section. Thus, a first element, component, region, or section discussed below could be termed a second element, component, region, or section without departing from the disclosure.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” or “beneath” other elements or features would then be oriented “above” the other elements or features. Thus, the exemplary term “below” can encompass both an orientation of above and below. The device may be otherwise oriented (rotated 90° or at other orientations) and the spatially relative descriptors used herein interpreted accordingly.

### Definitions

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical, or other property, such as, for example, molecular weight, viscosity, etc., is from 100 to 1,000, it is intended that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, distances from a user of a device to a target.

The term “and/or” as used in a phrase such as “A and/or B” herein is intended to include both A and B; A or B; A (alone); and B (alone). Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

As used herein, a “microdisplay” comprises image-creating pixel modulation. In one embodiment, the microdisplay is an emissive active display. Emissive active displays, including but not limited to Organic light-emitting diodes (OLED) and Light-Emitting Diodes (LED), feature the image and light source in a single device, and therefore an external light source is not required. This minimizes system size and power consumption, while providing exceptional contrast and color space. OLEDs are made from ultra-thin organic semiconducting layers, which light up when they are connected to voltage (charge carriers become injected and luminance mainly is proportional to the forward current). The major layers comprise several organic materials in sequence (for example, charge transport, blocking and emission layers—each with a thickness of several nanometers), which are inserted between an anode and a cathode. The terms “active display,” “digital display” and “microdisplay” are used interchangeably.

As used herein, “ballistics” is a way to precisely calculate the trajectory of a bullet based on a host of factors.

As used herein, an “enabler” is a system or device that can be used with a viewing optic. In one embodiment, an enabler is a system or device that can provide information that aids the user of a viewing optic. In one embodiment, an enabler is a system or device that can couple to a portion of a viewing optic. In one embodiment, an enabler includes but is not limited to laser range finder, a camera, a compass module, a communication module, a laser aiming unit, an illuminator, a back-up sight (iron sights, red dots, or another sight), a pivoting sighting module, or other devices useful to the user. As used herein, the terms “enabler” and “enabler device” are used interchangeably.

As used herein, an enabler interface is a location that allows an enabler to be coupled to a viewing optic.

As used herein, an “erector sleeve” is a protrusion from the erector lens mount which engages a slot in the erector tube and/or cam tube or which serves an analogous purpose. This could be integral to the mount or detachable.

As used herein, an “erector tube” is any structure or device having an opening to receive an erector lens mount.

As used herein, the term “firearm” refers to any device that propels an object or projectile, for example, in a controllable flat fire, line of sight, or line of departure, for example, handguns, pistols, rifles, shotgun slug guns, muzzleloader rifles, single shot rifles, semi-automatic rifles and fully automatic rifles of any caliber direction through any media. As used herein, the term “firearm” also refers to a remote, servo-controlled firearm wherein the firearm has auto-sensing of both position and directional barrel orientation. The shooter is able to position the firearm in one location and move to a second location for target image acquisition and aiming. As used herein, the term “firearm” also refers to chain guns, belt-feed guns, machine guns, and Gattling guns. As used herein, the term firearm also refers to high elevation, and over-the-horizon, projectile propulsion devices, for example, artillery, mortars, canons, tank canons or rail guns of any caliber.

As used herein, the term “flood light” refers to large amount of light provided to a particular area. In one embodiment, the light is provided by one or more light emitting diodes.

As used herein, a “focused light beam” illuminates objects at longer distances. A focused light beam has a narrow path of light emission with minimal diffusion.

As used herein, the term “illumination enabler” refers to a device configured to emit at least one type of light. The terms “illumination enabler,” “illumination device,” and “illuminator” are used interchangeably.

As used herein, a “reticle,” in one embodiment, is an aiming pattern for a viewing optic, such as, but not limited to, a crosshair aiming point or other aiming pattern.

As used herein, the term “viewing optic” refers to an apparatus used by a shooter or a spotter to select, identify or monitor a target. The “viewing optic” may rely on visual observation of the target, or, for example, on infrared (IR), ultraviolet (UV), radar, thermal, microwave, or magnetic imaging, radiation including X-ray, gamma ray, isotope and particle radiation, night vision, vibrational receptors including ultra-sound, sound pulse, sonar, seismic vibrations, magnetic resonance, gravitational receptors, broadcast frequencies including radio wave, television and cellular receptors, or other image of the target. The image of the target presented to the shooter by the “viewing optic” device may be unaltered, or it may be enhanced, for example, by magnification, amplification, subtraction, superimposition, filtration, stabilization, template matching, or other means. The target selected, identified, or monitored by the “viewing optic” may be within the line of sight of the shooter, or tangential to the sight of the shooter, or the shooter's line of sight may be obstructed while the target acquisition device presents a focused image of the target to the shooter. The image of the target acquired by the “viewing optic” may be, for example, analog or digital, and shared, stored, archived, or transmitted within a network of one or more shooters and spotters by, for example, video, physical cable or wire, IR, radio wave, cellular connections, laser pulse, optical, 802.11b or other wireless transmission using, for example, protocols such as html, SML, SOAP, X.25, SNA, etc., Bluetooth™, Serial, USB or other suitable image distribution method. The term “viewing optic” is used interchangeably with “optic sight.”’

As used herein, the term “outward scene” refers to a real-world scene, including but not limited to a target. The term “outward scene” and “target image” are used interchangeably.

As used herein, the term “shooter” applies to either the operator making the shot or an individual observing the shot in collaboration with the operator making the shot.

In one embodiment, the disclosure relates to a prism. In another embodiment, the disclosure relates to an optical prism. In one embodiment, the disclosure relates to a viewing optic with a prism or optical system disclosed herein. In one embodiment, the viewing optic is a red dot sight or a holographic red dot sight or a closed red dot sight or a mini red dot sight.

In one embodiment, the disclosure relates to an optical system comprising a free form optical prism and a microdisplay to overlay a digital image on an image of an outward scene. In one embodiment, the digital image is presented to the user with an extremely forgiving and comfortable eyebox.

In one embodiment, the disclosure relates to a free form optical prism, which accepts an image from a microdisplay and a correcting lens, which accepts the image of the outward scene. In one embodiment, the correcting lens is cemented onto the front surface of the prism. In one embodiment, both the free form prism and the correcting lens are intended to be molded out of optical polymers. The material, coatings, and optical paths can differ as needed to produce the best product for the needs of the user.

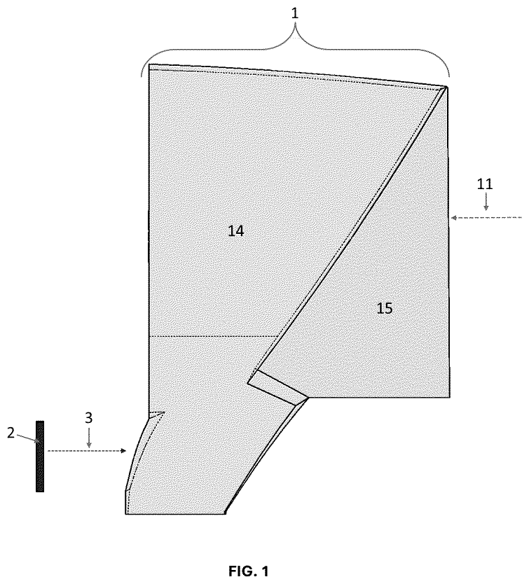

FIG. 1 provides a representative embodiment of an optical system comprising an optical prism and a microdisplay. The optical prism (1) is a doublet is made of two prisms. The primary prism (14) and the corrective prism (15). The primary prism (14) corrects and directs the light of the display image (3) from the microdisplay (2). The corrective prism (15) corrects, removes distortion from, and directs the light of, the image from the outward scene (11).

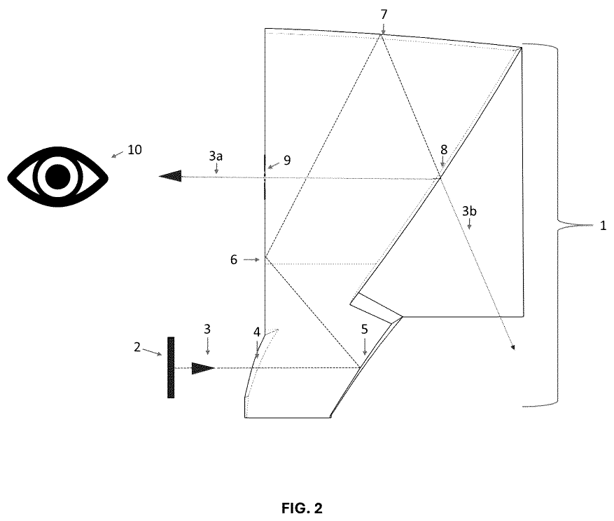

As shown in FIG. 2, the microdisplay (2) generates an image (3) through the primary prism's (14) optical path and to the user's eye (10). In other words, the microdisplay (2) shines the display image (3) through the optical path of the primary prism (14) and to the user's eye (10).

The image from the microdisplay (3) enters the prism (1) and is corrected at the first primary prism surface (4) to begin collimation of the light rays and to correct for the significant coma (CO3) that is induced by this type of optical system design. The image (3) from the microdisplay (3) then hits the second primary prism surface (5), which has a mirror coating to provide as close to 100% reflectivity as possible. The second primary prism surface (5) also has an associated optical power that works to correct the image (3) and begin the expansion of the image needed to create the large exit pupil. The second primary prism surface (5) is the only surface with negative optical power and is responsible for expanding the column of light from the display image (3), which makes the large exit pupil possible.

The image from the microdisplay (3) is bounced to the third primary prism surface (6), which is uncoated. Due to the angle at which the light from the image (3) strikes the uncoated surface, total internal reflection (TIR) prevents the light from escaping the prism. The image (3) is bounced off the fourth primary prism surface (7), which also has a mirror coating that is as close to 100% reflectivity as possible. The fourth primary prism surface (7) also has an associated optical power that works to correct the image (3) and continue to collimate the light.

The image (3) then strikes the fifth primary prism surface (8), which has a coating that controls transmission. This splits the light of the display image (3) into two separate optical paths. For this example, the coating will allow for 50% light transmission, but any percent can be used.

The discarded display image light (3b) passes through the fifth primary prism surface (8) and passes out of the optical path of the beam splitter prism (1). Importantly, the discarded display image light (3b) will mostly be absorbed by the prism walls and the sight shroud, this will prevent the dreaded “forward emission” of light which can give away a user's position to an entity which is in front of the sight.

The remaining display image light (3a) is reflected off the fifth primary prism surface (8), which has a slight curvature, and is “half-silvered,” and is the final corrective surface of the optical system. The remaining display image light (3a) intersects the third primary prism surface (6) at the rear of the prism (9) and due to the angle of incidence, the remaining display image light (3a) passes through the rear of the prism (9) unimpeded where it then travels to the user's eye (10).

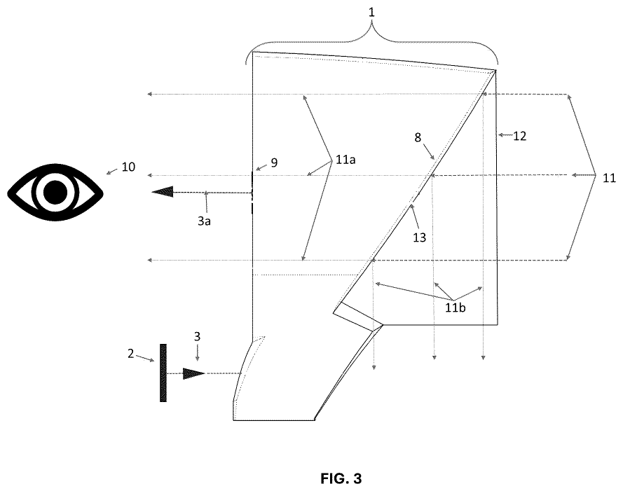

As shown in FIG. 3, the “half silvered” fifth surface (8) also allows image scene (11) to pass through to the user's eye (10). The image scene light (11) enters the beam splitter prism (1) at the face of the corrective prism surface (12). This surface is plano and has an anti-reflection coating applied to it; power could be added to the surface if optical correction is needed.

The image scene light (11) then transmits through the fifth primary prism surface (8). The fifth primary prism surface (8), which has half-silvered coating, splits the image scene light (11). Half of the image scene light (11b) is reflected off the fifth primary prism surface (8) and passes out of the optical path of the beam splitter prism (1).

The remaining image scene light (11a) passes through the fifth primary prism surface (8). The remaining image scene light (11a) intersects the third primary prism surface (6) at the rear of the prism (9) and due to the approach angle, the remaining image scene light (11a) passes through the rear of the prism (9) unimpeded where it then travels to the user's eye (10).

The coating of the fifth primary prism surface (8) reflects the same percentage of the discarded image scene light (11b) as the percentage of the remaining display image light (3a). The result is the inverse percentage of the remaining image scene light (11a) is allowed to pass through the fifth primary prism surface (8). When summed, the percentage of remaining display image light (3a) and the percentage of the remaining image scene light (11a) equals 100%, or as close to 100% as possible.

For this example, the fifth primary prism surface (8) has a 50% reflection. The result is that the remaining display image light (3a) is 50% of the original display image (3) and the remaining image scene light (11a) that passes through fifth primary prism surface (8) is 50% of the original image scene light (11). However, any combination of percentages can be used in order to achieve the desired contrast ratio between the display image light (3a) and the image scene light (11a).

If the fifth primary prism surface (8) had 75% reflection, then the remaining display image light (3a) would be 75% of the original display image (3) light and the remaining image scene light (11a) that passed through fifth primary prism surface (8) would be 25% of the original image scene light (11).

In addition to the brightness of the display (2), the percent of the remaining display image light (3a) that is reflected by the fifth primary prism surface (8) and the percent of the remaining image scene light (11a) that passes through the fifth primary prism surface (8) determines the brightness of remaining display image light (3a) against the brightness of the remaining image scene light (11a) as seen by the user's eye (10).

For the user, when compared to the 50% reflection, the 75% reflection would result in a brighter display image (3) against dimmer image scene light (11).

In another embodiment, the second corrective prism surface (13) has coating, and fifth primary prism surface (8) does not. In another embodiment, both the second corrective prism surface (13) and the fifth primary prism surface (8) have coatings applied, but in that scenario the sum of the light may or may not sum to 100%.

In one embodiment, the viewing optic having an optical system disclosed herein can have buttons, rotary knobs, or other controls mounted on any relevant side. The controls could also be mounted on a separate remote in addition to, or in leu of the controls on the body of the viewing optic. The remote could physically attached to viewing optic or it could be connected wirelessly. The viewing optic could also be connected wirelessly or via cable to a phone, tablet, computer, or another device to change settings, update software, control the viewing optic or issue any other commands or interactions. In another embodiment, the viewing optic having an optical system disclosed herein could have a wireless internet connection, or a connection to another wireless network, that would allow it to perform those same functions without the need of another device.

### Microdisplay

In one embodiment, the viewing optic has an optical system with a microdisplay. In one embodiment, the viewing optic has an optical system with two or more microdisplays. In one embodiment, the microdisplay is controlled by a microcontroller or computer. In one embodiment, the microdisplay is controlled by a microcontroller with an integrated graphics controller to output video signals to the display. In one embodiment, information can be sent wirelessly or via a physical connection into the viewing optic via a cable port. In still another embodiment, numerous input sources can be input to the microcontroller and displayed on the active display.

In one embodiment, the microdisplay can be a reflective, transmissive or an emissive micro-display including but not limited to a micro display, transmissive active matrix LCD display (AMLCD), Organic light-emitting diode (OLED) display, Light-Emitting Diode (LED) display, e-ink display, a plasma display, a segment display, an electroluminescent display, a surface-conduction electron-emitter display, a quantum dot display, etc.

In one embodiment, the LED array is a micro-pixelated LED array, and the LED elements are micro-pixelated LEDs (also referred to as micro-LEDs or uLEDs in the description) having a small pixel size generally less than 75 μm. In some embodiments, the LED elements may each have a pixel size ranging from approximately 8 μm to approximately 25 μm and have a pixel pitch (both vertically and horizontally on the micro-LED array) ranging from approximately 10 μm to approximately 30 μm. In one embodiment, the micro-LED elements have a uniform pixel size of approximately 14 μm (e.g., all micro-LED elements are the same size within a small tolerance) and are arranged in the micro-LED array with a uniform pixel pitch of approximately 25 μm. In some embodiments, the LED elements may each have a pixel size of 25 μm or less and a pixel pitch of approximately 30 μm or less.

In some embodiments, the micro-LEDs may be inorganic and based on gallium nitride light emitting diodes (GaN LEDs). The micro-LED arrays (comprising numerous uLEDs arranged in a grid or other array) may provide a high-density, emissive micro-display that is not based on external switching or filtering systems. In some embodiments, the GaN-based, micro-LED array may be grown on, bonded on, or otherwise formed on a transparent sapphire substrate.

In one embodiment, the sapphire substrate is textured, etched, or otherwise patterned to increase the internal quantum efficiency and light extraction efficiency (i.e., to extract more light from the surface of the micro-LEDs) of the micro-LEDs. In other embodiments, silver nanoparticles may be deposited/dispersed on the patterned sapphire substrate to coat the substrate prior to bonding the micro-LEDs to further improve the light efficiency and output power of the GaN-based micro-LEDs and of the micro-LED array.

In one embodiment, the microdisplay can be monochrome or can provide full color, and in some embodiments, can provide multi-color. In other embodiments, other suitable designs or types of displays can be employed. The microdisplay can be driven by electronics. In one embodiment, the electronics can provide display functions, or can receive such functions from another device in communication therewith.

In one embodiment, the microdisplay can be part of a backlight/display assembly, module, or arrangement, having a backlight assembly including a backlight illumination or light source, device, apparatus, or member, such as an LED backlight for illuminating the active display with light. In some embodiments, the backlight source can be a large area LED and can include a first or an integrated lens for collecting and directing generated light to a second, illumination or condenser lens, for collecting, concentrating, and directing the light onto active display, along display optical axis B, with good spatial and angular uniformity. The backlight assembly and the active display are able to provide images with sufficient high brightness luminance to be simultaneously viewed with a very high brightness real world view through optics, while being at low power.

The backlight color can be selected to be any monochrome color or can be white to support a full color microdisplay. Other backlight design elements can be included, such as other light sources, waveguides, diffusers, micro-optics, polarizers, birefringent components, optical coatings, and reflectors for optimizing performance of the backlight, and which are compatible with the overall size requirements of the active display, and the luminance, power, and contrast needs.

Representative examples of microdisplays that can be used include but are not limited to: Microoled, including MDP01 (series) DPYM, MDP02, and MDP05; Emagin such as the SVGA, micro-displays with pixel pitches are 9.9×9.9 micron and 7.8×7.8 micron, and Lightning Oled Microdisplay, such as those produced by Kopin Corporation. Micro LED displays can also be used including but not limited to those produced by VueReal and Lumiode.

In one embodiment, the electronics working with the microdisplay can include the ability to generate display symbols, format output for the display, and include battery information, power conditioning circuitry, video interface, serial interface, and control features. Other features can be included for additional or different functionality of the display overlay unit. The electronics can provide display functions or can receive such functions from another device in communication therewith.

In one embodiment, the microdisplay can generate images including but not limited to text, alpha-numeric, graphics, symbols, and/or video imagery, icons, etc., including active target reticles, range measurements and wind information, GPS and compass information, firearm inclination information, target finding, recognition and identification (ID) information, and/or external sensor information (sensor video and/or graphics), or images for situational awareness, for viewing through the eyepiece along with the images of the view seen through optics. The direct viewing optics can include or maintain an etched reticle and bore sight and retain high resolution.

In one embodiment, the utilization of a microdisplay allows for a programmable electronic aiming point to be displayed at any location in the field of view. This location could be determined by the user (as in the case of a rifle that fires both supersonic and subsonic ammo and thus has two different trajectories and “zeros”) or could be calculated based upon information received from a ballistic calculator. This would provide a “drop compensated” aiming point for long range shooting that could be updated on a shot-to-shot interval.

In another embodiment, the viewing optic may include memory, at least one sensor, and/or an electronic communication device in electronic communication with the processor.

### Representative Information Projected by the Microdisplay

Method of Use for Range Finding. In one embodiment, the microdisplay can display range measurements obtained from a laser rangefinder. In one embodiment, a LRF can be coupled to a viewing optic. In one embodiment, the LRF is directly coupled to the outer scope body of the riflescope. In another embodiment, a portion of a LRF is directly coupled to the outer portion of the scope body of the riflescope.

In one embodiment, the LRF is indirectly coupled to the outer scope body of the riflescope. In another embodiment, a portion of a LRF is indirectly coupled to the outer portion of the scope body of the riflescope.

In yet another embodiment, a LRF is not coupled to the riflescope but communicates with the riflescope via either hard-wiring or wirelessly.

In general operation, a LRF provides a pulse of laser light that is projected into the scene via the projection optics. This laser light illuminates the object, and a portion of the laser light is reflected back toward the LRF. Part of the reflected laser light returning to the device is captured by the receiving optical system and is directed to a detector. The device includes a timer starting when the laser light pulse is transmitted and stopping when the returning laser light is detected. A calculator portion of the device uses the elapsed time from transmission of the laser light pulse until detection of the returning reflected laser light to calculate the distance to the object.

Windage Range Bar. In another embodiment, the microdisplay can generate a windage range. In one embodiment, a user can supply a range of wind values, and software can generate windage data, for example a windage range variance bar.

In one embodiment, the windage data includes the minimum wind hold point to the maximum wind hold point.

In one embodiment, the windage data is transmitted to the microdisplay, and the active display can generate a digital reticle into the field of view at the appropriate wind hold.

Display Colors for Mental Cues. In one embodiment, the microdisplay can generate a color display to convey an extra level of information to the user in a quick-to-comprehend format. In one embodiment, the microdisplay can generate a series of color-coded symbols to indicate a readiness to fire.

In one embodiment, the microdisplay can generate a series of color-coded symbols to color code objects in the image scene. In one embodiment, the microdisplay can color code friendly forces from enemy forces. In another embodiment, the microdisplay can color code targets of interest.

In one embodiment, the microdisplay can generate a series of color-coded symbols to indicate status of windage adjustment. In one embodiment, a red dot can indicate that windage adjustment has not been completed while a green symbol could indicate that windage adjustment has been completed.

In another embodiment, the microdisplay can generate an aiming point with color. In one embodiment, the aiming point would be a red color if proper adjustments, including but not limited to windage, range, and elevation, have not been performed. In another embodiment, the aiming point would be a yellow color if some but not all shooting adjustments have been completed. In still another embodiment, the aiming point would be green if all the requisite shooting adjustments have been completed, and the aiming point is fully compensated.

In yet another embodiment, flashing and steady states of symbols may be utilized to convey similar status information regarding the adjustment of the aiming point.

In still another embodiment, the microdisplay can generate text that is shown in colors to indicate status. In one embodiment, red text can indicate that in input parameter has not been entered or calculated, and green for text indicating a parameter which has been input or calculated.

Markers for Impact Zone in Range Finding. In one embodiment, an microdisplay can generate circles, squares, or other shapes to allow the user to quickly encompass or encircle the impact zone of a projectile.

Hold-over Estimation and Compensation. In another embodiment, the microdisplay can generate an aiming point compensated for a moving target based on user input for the direction and rate of movement. For example, the user may input a rate of movement of 5 miles per hour to the left. This would be added to the windage value if the wind and movement are in the same direction and subtracted from the windage value if the wind and movement are in opposite direction. Then, when the aiming point and/or windage value bar are plotted on the display, the aiming point will include the proper amount of hold-over to allow the user to place the aiming point dot on the desired impact zone and take the shot, rather than to have to place the aiming point ahead of the moving target to compensate for movement.

Team Operation via Camera and Remote Display Manipulation. In one embodiment, the microdisplay in conjunction with a network interface allow for an additional level of enhanced operation and usage. In one embodiment, the reticle images of a plurality of shooters over a network can be viewed. Each shooter's reticle camera image is shown on one or more consoles, and network processes and interfaces enable a group-level of coordination, training, and cooperation not before available in individual riflescopes.

Training and Coaching. In a training or coaching scenario, the coach can see how each shooter has aligned his or her reticle on his or her respective target. By being able to actually see the reticle alignment, the coach or trainer can then provide instructions on adjustments and repositioning, such as by verbal instructions (e.g. by radio or in person).

In another embodiment, the coach's console can be provided with a pointing means, such as a mouse or joystick, for which control data is transferred from the console to the rifle's integrated display system via the network. This coach's mouse or joystick then controls an additional dot or pointer in the display of the scope of each shooter, which allows the coach to visually show the shooter which target to use, which range marker bar to use, and where to position the reticle relative to the target. In one embodiment, each shooter can be provided with his or her own coach's dot so that the coach may provide individualized instruction to each shooter.

Fire Coordination. In another embodiment, the microdisplay can be used in the coordination and implementation of a multi-shooter fire team. In one embodiment, the commander of the team operates a coach's console and uses the coach's dots to assist in assigning targets to each shooter, communicating changes in reticle placement, etc.

Snapshots for Remote Review and Approval. In another embodiment, the microdisplay and network processes can allow the shooter, provided with a control means, to take a “snapshot” of his or her reticle view. This snapshot of the user's reticle view can include an image of a target of question. When the image is received by the commander or coach, the commander or coach review the image and approve or disapprove taking the shot. For example, in a coaching scenario, the user may take a snapshot of an animal he or she believes is a legal animal (age, species, gender, etc.) to take. If the coach agrees, the coach can so indicate by positioning or moving the coach's dot in the shooter's reticle.

Biometric Classification of Target. In another embodiment, the snapshot of the reticle image is received by a biometric recognition and/or classification process, such as a facial recognition system. The biometric recognition and/or classification process may be on board the gun, such as being integrated into the display control logic, or may be remote to the gun interconnected via the network. The results of the recognition and/or classification process may be provided in the reticle by transmitting the results via the network to the control logic and updating the display appropriately.

Side-by-Side Image Display. In another embodiment, an image is downloaded to the viewing optic via the network and is displayed coincidentally in the reticle with the viewed images of target. A downloaded image can be used to make a side-by-side comparison by the user of the currently viewed target with a previously taken image or photo of a target similar to that which the shooter is instructed or desiring to take. For example, during doe season, a new shooter may be provided an image of a deer doe for reference in the reticle, which can be compared in real time to the actual animal being viewed through the scope. In a military or law enforcement application, an image of a sought enemy or fugitive can be displayed in the reticle for real-time comparison by a sniper to face of a person being viewed through the scope.

In one embodiment, the microdisplay is a 530-570 nm micro display. In one embodiment, the microdisplay is an AMOLED micro display.

### Enablers

In one embodiment, the viewing optic can be designed with one or more enabler interfaces. In one embodiment, the enabler interface can include physical, electrical and or software specifications that allow the viewing optic to have additional capability. Such enablers could include, but are not limited to, traditional riflescopes of fixed or variable magnification, remotes, laser range finders (LRFs), ballistic calculators, thermal cameras, day cameras, night vision cameras, wind readers, stabilizers, compasses, aiming laser modules, battery packs, illuminators, a flood light enabler, a focused light beam enabler, or any other relevant devices. These enablers could be permanently integrated into the viewing optic, or may be removable at by the factory, the user, or at another level. In one embodiment, multiple enablers could be connected or integrated in the viewing optic at the same time.

In one embodiment, the enablers can be physically mounted to the viewing optic or mounted in another convenient location such as on the firearm or on the user. Communication could occur via a wired or wireless interface. Examples of the wireless interfaces could include but are not limited to Bluetooth, wifi, ultra-wideband (UWB), or any other appropriate network. The viewing optic itself may have the wireless capability and/or wireless capability may be onboard the enablers.

If the enabler requires software processing the processing hardware may reside within the viewing optic, within the enabler, or on another device. In one embodiment, power for enablers may be drawn from the viewing optic or the enablers may have their own batteries.

In one embodiment, the microdisplay of the viewing optic can generate a single point of aim or multiple point/s of aim, ballistic corrections, headings, inclinations, video feeds, target reference points (TRPs), augmented reality data, training information, or any other information relevant to the user. Information can be alpha numeric and/or displayed as symbols, graphics, or any other relevant format.

### Representative Configurations

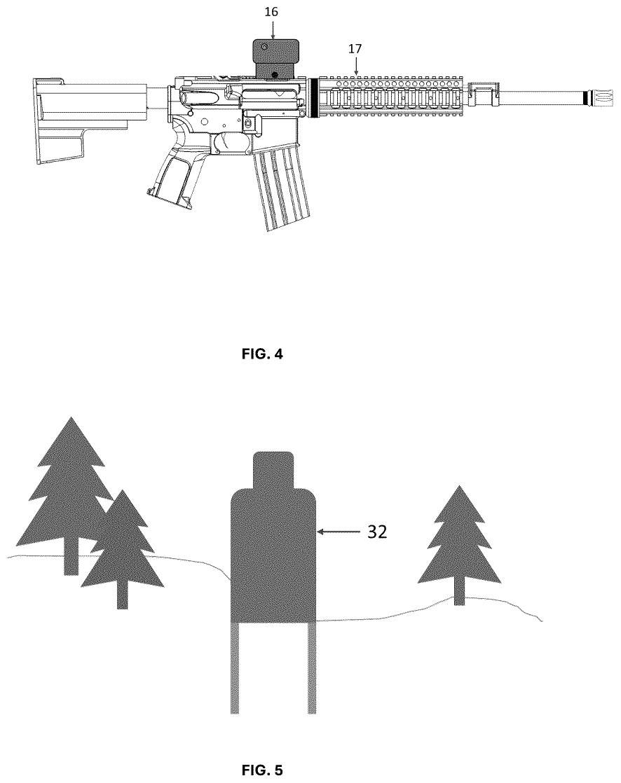

As shown in FIG. 4, the viewing optic can function as a standalone 1× viewing optic (16) for a firearm, such as a rifle (17). The 1× optic has infinite eye relief for the user and could take any size.

FIG. 5 shows a bare image scene with a target (32). This is what the image scene would look with the naked eye. FIGS. 6A and 6B show renderings looking through the viewing optic with an optical system disclosed herein (16) with a digitally projected reticle (33/33a). The digitally projected reticle (33/33a) is shown as a large dot, but this could be any size, shape or color. Likewise, the housing and viewing window of the 1× Smart Sight (16) are rectangular in the rendering, but the housing and viewing window can be any relevant size or shape.

For the purposes, of this disclosure, several types of projected reticle are demonstrated, such as a large dot reticle (33a), a refined aimpoint reticle (33b) and ballistic hold reticle (33c). However, a digitally projected reticle can be any size, shape or color and it is no way limited to the drawings disclosed herein.

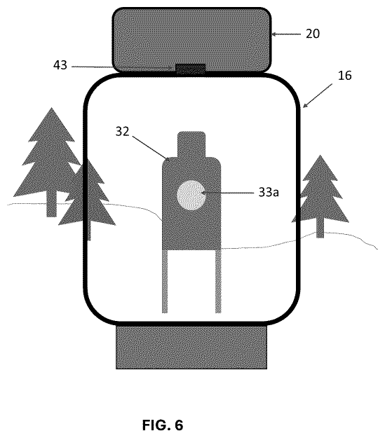

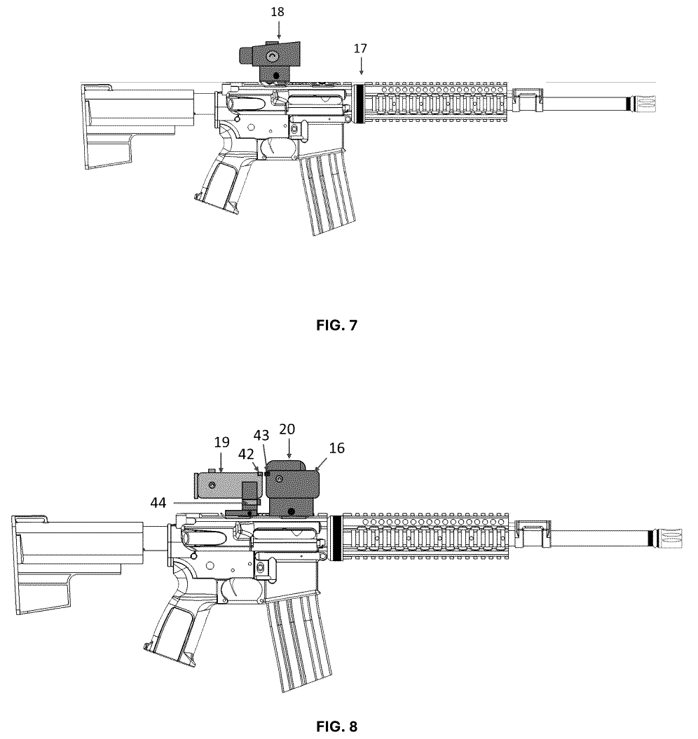

In another embodiment, the disclosure relates to a viewing optic with an optical system having a prism optically designed to both display a digital image (33) and magnify the outward scene (18). A representative non-limiting example is shown in FIG. 7.

In another embodiment, the prism (1) can display the generated image from the microdisplay and passing through the image of the outward scene with lenses in front of or behind the prism to magnify the image of the outward scene. In one embodiment, the viewing optic could be made into a fixed sight with an integrated etched reticle. In another embodiment, the magnification of the viewing optic could also be variable in nature. \

In another embodiment, the disclosure relates to a viewing optic with an optical system disclosed herein (16) with a magnifier (19) mounted behind the viewing optic (16). A representative non-limiting example is shown in FIG. 8. This embodiment also shows a LRF (20) attached to the viewing optic (16).

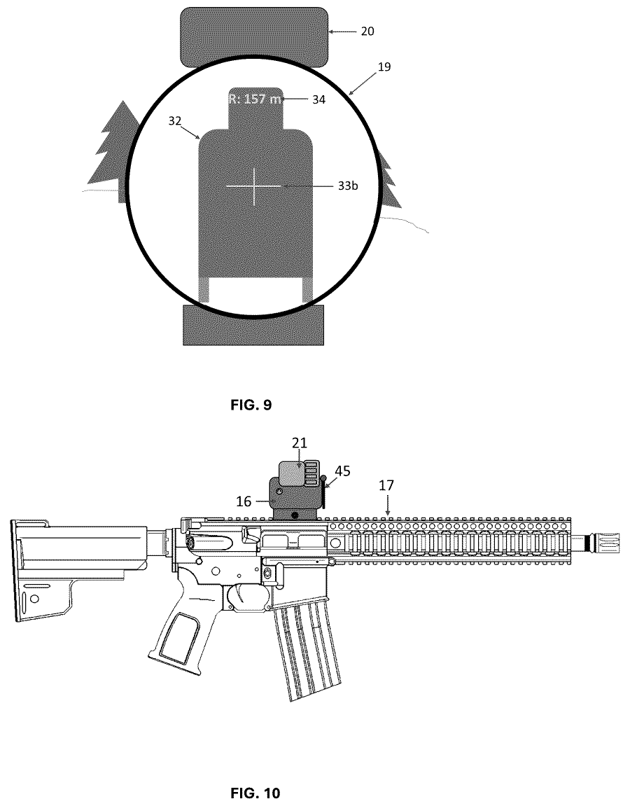

FIG. 9 shows a view through rendering of the viewing with an optical system as disclosed herein. The image scene, and therefore the target (32), is magnified by the magnifier (19). A LRF (20) sends range data to the viewing optic with an optical system disclosed herein (16) and the range to the target (34) is displayed in addition to a refined aimpoint reticle (33b).

In another embodiment, the disclosure relates to a viewing optic with an optical system disclosed herein (16) connected to an imaging enabler (21). The imaging enabler (21) could be fully integrated into viewing optic (16) or be modular in nature. A representative non-limiting example is shown in FIG. 10.

The imaging enabler could be a thermal camera of any wavelengths, a day and/or night camera, or any relevant camera technology. The camera could display the image inside the viewing optic (16) using the viewing optic's internal microdisplay (2). This makes the imaging enabler (21) much smaller and power efficient as compared to traditional designs because the imager would not require its own separate display. Processing of the image could be performed on the viewing optic (16) or the imaging enabler (21). The design of the viewing optic (16) would allow the user to see hot spots or point of interest highlighted and/or overlaid on the image scene.

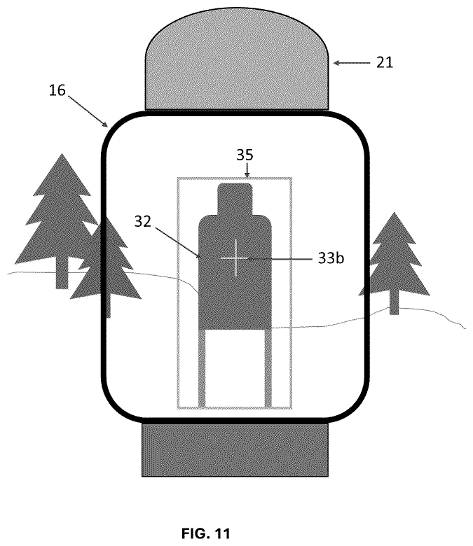

FIG. 11 shows a view through rendering of the viewing optic with an optical system disclosed herein connected to an imaging enabler. The imaging enabler (21) uses a camera to see the image scene. The imaging enabler (21) then processes the image and identifies the target (32) as a point of interest. This information is transmitted to the viewing optic (16). The viewing optic (16) then draws an outline (35) the target (32). In FIG. 11, the hot spot highlight is a box outline (35), but other shapes could be used. For example, an outline could be traced around the edge of the target (32). Alternatively, the point of interest may be identified in some other manner. FIG. 11 shows the outline (35) in a different color than the digitally projected reticle (33), but the two could be the same color. Like the digitally projected reticle (33), the outline (35) could be any color.

In another embodiment, the imaging enabler (21) could be mounted off the viewing optic (16) but in an offset or low-profile location on the weapon so as not to obstruct the image scene (11) from entering the viewing optic like a traditional front mounted clip-on imager (23). In one embodiment, the imaging enabler should be mounted in a fixed location or in a repeatable mount so that the viewing optic (16) can account for any potential misalignment if positionally relevant overlaid images are desired.

Regardless of the mounting location, the imaging enabler (21) should be mounted in fixed location or with a repeatable mount so that the viewing optic (16) can account for any potential misalignment if positionally relevant overlaid images are desired.

In another embodiment, the imaging enabler (21) sends a full video feed to be displayed within the viewing optic (16) rather than just points of interest. If the display image (3) is too dim to see the entire display range against bright image scene light (11) the viewing optic (16) could artificially dim the image scene light (11) though the use of a lens cap (45) or another mechanism. The lens cap could be fully opaque or translucent to some degree. It could be attached and/or move/articulate however is most appropriate for the viewing optic design.

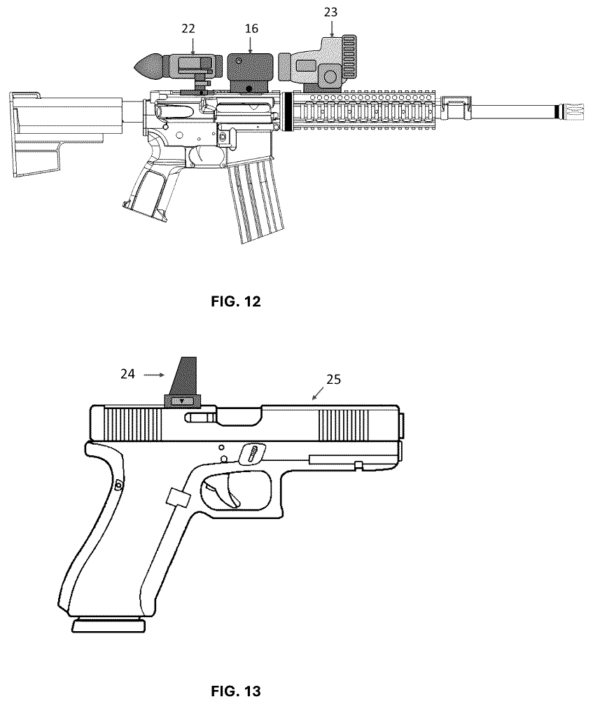

In another embodiment, the viewing optic with an optical system disclosed herein can function with a rear mounted imaging enabler (22) mounted behind the viewing optic (16) and/or a front rail mounted clip-on imager (23) mounted in front of the viewing optic (16). A representative non-limiting example is shown in FIG. 12. The imaging enablers (22 and 23) could be camera based with their own displays, traditional Image Intensified Night Vision that passes an image through the optic, or another technology.

In another embodiment, the unlimited eye relief of the viewing optic (16) would allow it to be easily used for a passive aiming though user worn night vision devices.

In another embodiment, the discloser relates to a viewing optic with an optical system disclosed herein (24), with a smaller window sized for use on a handgun (25). The rugged nature, the fact it does not require mechanical adjustments to adjust the location of the digitally projected reticle (33), an infinite eye relief and the opportunity for a small footprint would make the viewing optic (24) an excellent optic for handguns (25). A representative non-limiting example is shown in FIG. 13.

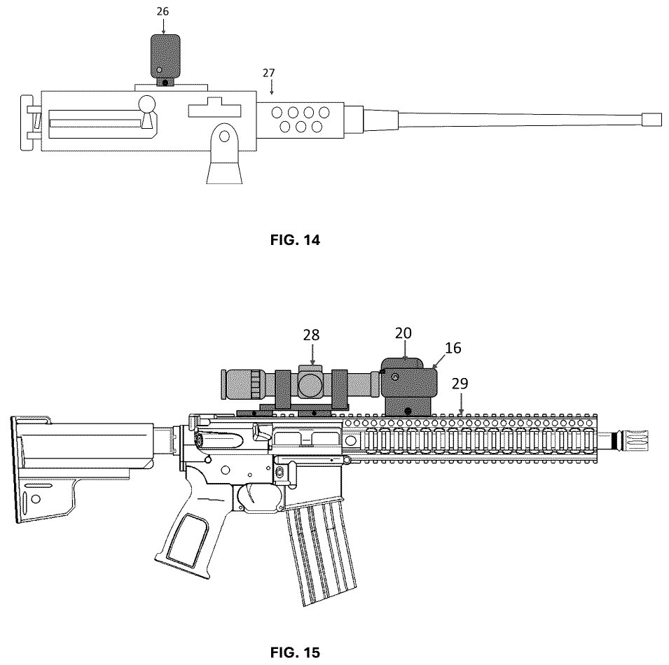

In another embodiment, the disclosure relates to a viewing optic (26) with an optical system disclosed herein with a large window sized for use on a machine gun (27) or another crew served weapon. A representative non-limiting example is shown in FIG. 14.

The durability, lack of mechanical adjustments, infinite eye relief and massive window would make it a very good pairing for turret mounted weapons, and other large weapons. The unlimited eye relief would be helpful to ensure the user has a useable sight picture when in unorthodox shooting positions, such as when the user is a foot or more from the large viewing optic (26). The unlimited eye relief would also speed up acquisitions, and the viewing optic could be large enough to allow the user to look through the very large viewing optic (26) with both eyes. When used in conjunction with other enablers, such as LRFs (20), magnifiers (19), and/or thermal imagers (21), the viewing optic (26) could provide turret gunners, and other users, with substantial capability that would allow them to put rounds easily and effectively on targets at extended distances.

In another embodiment, this configuration could be made into a magnified viewing optic (18) but the unlimited eye relief of a 1× viewing optic (26) would likely be of greater benefit than the integrated magnification.

In another embodiment, the disclosure relates to a viewing optic with an optical system disclosed herein (16) but mounted in front of, and aligned to, a traditional magnified riflescope (28). A representative non-limiting example is shown in FIG. 15. The images show a Low Power Viewing Optic, but it could be an optic of any magnification range, to include fixed power optics. While not required, this embodiment offers the most capability when the viewing optic (16) is paired with an LRF (20) and/or imaging enabler (21).

In the configuration of this embodiment, the user would have an etched reticle (36) from the traditional magnified riflescope (28), but the viewing optic (16) could provide ballistic drop data for the user. Being as the viewing optic (16) would be mounted in front of the traditional magnified riflescope (28), and therefore in front of the first focal plane of the traditional magnified riflescope (28), any ballistic drops the viewing optic (16) displayed would be both within the field of view of the optic and be accurate at any magnification the traditional magnified riflescope (28) was set to.

The traditional riflescope has a main optical system comprised of an objective lens system that focuses an image from a target down to a first focal plane (hereafter referred to as the “FFP Target Image”), followed by an erector lens system that inverts the FFP Target Image and focuses it to a second focal plane (hereafter referred to as the “SFP Target Image”), a an eyepiece lens system that collimates the SFP Target Image so that it can be observed by the human eye, and a second optical system.

FIG. 16 shows the image scene through a traditional magnified riflescope (28). The scene is show as if the traditional magnified riflescope (28) were set to 1×. The etched reticle (36) of the traditional magnified riflescope (28) is shown over the target (32).

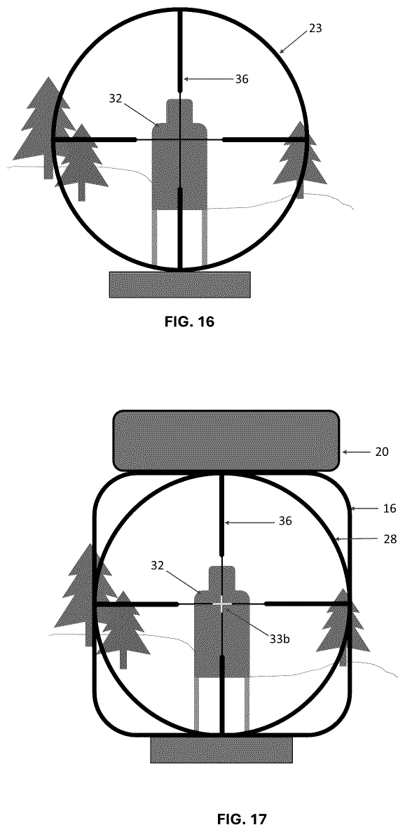

FIG. 17 shows the same image scene through a traditional magnified riflescope (28) set to 1×. A 1× viewing optic (16) has been placed in front of the traditional magnified riflescope (28). The digitally projected refined aimpoint reticle (33b) is aligned with the center of the etched reticle (36). To aid in the ease of the description, FIG. 17 shows the viewing optic (16) with a rectangular housing larger than the objective of the traditional magnified riflescope (28). In execution the viewing optic (16) may be any size or shape and it may be larger or smaller than the objective the traditional magnified riflescope (28) that sits behind the viewing optic with an optical system disclosed herein (16). The viewing optic (16) may have a larger or smaller field view than the traditional magnified riflescope (28) and the housing of the viewing optic (16) may or may not be visible and/or partially obscure the image scene through a traditional magnified riflescope (28).

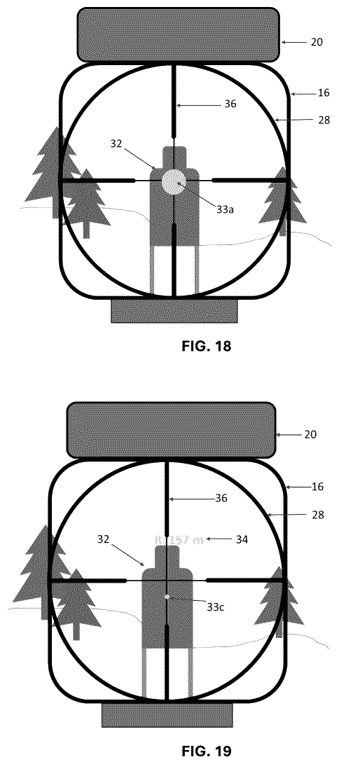

FIG. 18 shows the same image as shown in FIG. 16, but the digitally projected reticle (33) is shown as the large dot reticle (33a) for easier acquisition

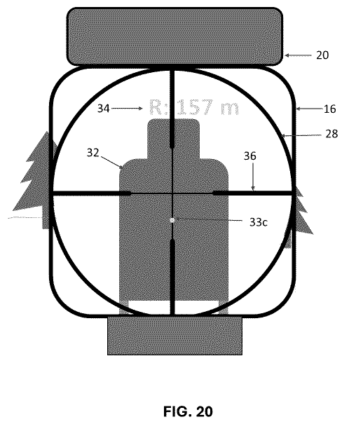

FIG. 19 shows the same image as FIG. 16 but with a ballistic hold reticle (33c) based off a ballistic solver that calculated the ballistic drop for the bullet using the range to the target (34) and the weapon and cartridge characteristics.

FIG. 20 shows the same image scene, but the traditional magnified riflescope (28) is magnified to a power beyond 1×. The ballistic hold reticle (33c) is at the same spot on the target (32) as FIG. 19 because the viewing optic with an optical system disclosed herein (16) is in front of the first focal plane of the traditional magnified riflescope (28). This makes the ballistic hold reticle (33c) accurate at any magnification setting of the traditional magnified riflescope (28). By contrast, the etched reticle (36) of the traditional magnified riflescope (28) in FIG. 20 is shown as a second focal plane reticle. This would make any associated ballistic drops on the etched reticle (36) be magnification dependent for accuracy.

In one embodiment, the viewing optic with an optical system disclosed herein (16) could be mounted to the weapon rail (29) in front of the traditional magnified riflescope (28) or mounted to the front of the traditional magnified riflescope (28) itself. Weapon mounted allows for easier alignment but mounting directly to/on a traditional magnified riflescope (28) may be preferred on some platforms and by some customers. The viewing optic with an optical system disclosed herein (16) could clamp around the objective assembly or mount to/on an interface on the traditional magnified riflescope (28).

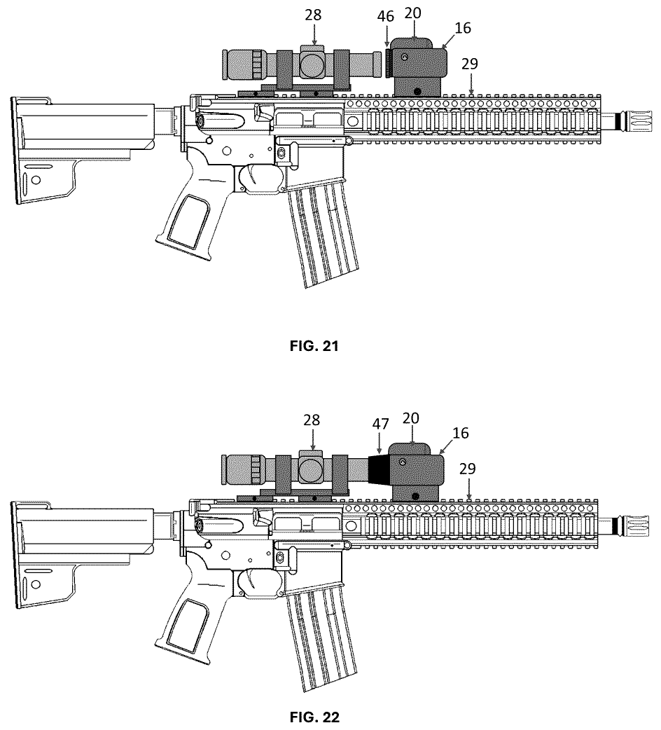

In another embodiment, the viewing optic (16) has an additional optical assembly (46) that allows the remaining display image light (3a) and the remaining image scene light (11a) to be focused for best viewing through the traditional magnified riflescope (28). FIG. 21 provides a representative example of this embodiment.

The optical assembly (46) could have as many or as few lenses as necessary and could in the front or rear or the viewing optic (16). The optical assembly (46) could be fixed for a specific scope, or it could be adjustable by the user or by another party.

In another variation of the embodiment, the display image (3) is corrected/adjusted before it impacts the first primary prism surface (4). This would allow the parallax of the viewing optic (16) to be adjustable, allowing for a better image when using the viewing optic (16) with a traditional magnified riflescope (28) with an adjustable parallax. The adjustment could be made during assembly, or it could be adjustable by the user or by another party. The viewing optic (16) could have an additional dial, lever, wheel, or another interface that allowed the user to adjust the parallax of the viewing optic (16). This adjustment could be tied to an operational mode or setting of the viewing optic (16). The viewing optic (16) could also measure the adjustment and display the current parallax setting to the user via the display.

In another embodiment, the viewing optic (16) parallax adjustment could be motorized. This would allow the user to set the parallax with an electronic command. If the corresponding traditional magnified riflescope (28) had a means of tracking and communicating its current parallax setting, the viewing optic (16) could adjust the parallax automatically to match the parallax setting of the traditional magnified riflescope (28).

In another variation of this embodiment, the viewing optic (16) has light shroud (47) that minimizes glare or light loss between the viewing optic (16) and the traditional magnified riflescope (28). A representative non-limiting embodiment is shown in FIG. 22.

The light shroud (47) could be of any appropriate size, shape, or material. The light shroud (47) could be attached to the viewing optic (16) and/or the traditional magnified riflescope (28) or could rest loosely between the two.

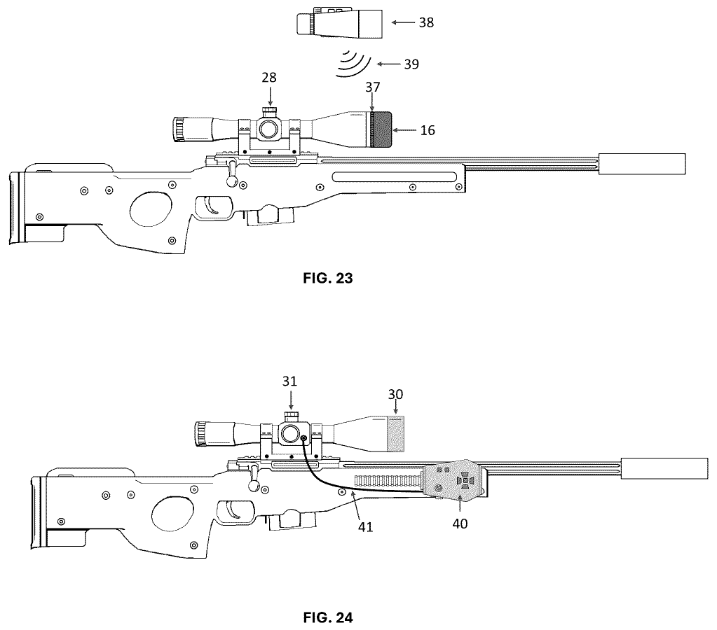

As previously mentioned, the viewing optic (16) could be mounted in front of a traditional magnified riflescope (28) via any appropriate manner including, but not limited to being mounted to the weapon rail (29) or being mounted to/on the traditional magnified riflescope (28) itself. Mounting to a solid weapon rail (29 would be the easiest alignment but mounting it directly to/on a traditional magnified riflescope (28) may be preferred on some platforms and by some users. In this circumstance, the viewing optic (16) could clamp around the objective assembly or mount to/on an interface on the traditional magnified riflescope (28), be it an existing interface or specialty designed. FIG. 23 provides a representative non-limiting example of this embodiment.

FIG. 23 depicts a viewing optic (16) threaded into the objective threads of the traditional magnified riflescope (28). The viewing optic (16) orientation is dictated via threaded lock ring (37) that helps secure the viewing optic (16) in place. A wireless laser rangefinder (38) sends a wireless signal (39) with the target range and the associated ballistic drop to the to the viewing optic (16).

In another embodiment, the viewing optic with an optical system as disclosed herein (30) can be integrated into the objective of a magnified optic (31). This would offer many of the benefits of the previous embodiment, but it would not be removable. This would offer additional environmental protections and could allow the viewing optic (30) to be better tailored to the optical system of the magnified optic (31).

FIG. 24 depicts a viewing optic (30) integrated directly into the objective of a magnified optic (31). FIG. 24 also shows the weapon mounted LRF enabler (40) that is connected to the viewing optic (30) via a cable (41) connected to the magnified optic (31). Alternatively, the cable could be connected directly to the Smart Sight (30). This configuration may be most useful with an integrated Laser Rangefinder (20), especially when used with high magnification optics for long range shooting.

In another embodiment, the viewing optic with an optical system disclosed herein (30) could be integrated into or mounted to the eyepiece of a magnified optic (31). However, as the viewing optic (30) would be mounted after the second focal plane of the magnified optic (31) it would be less ideal as ballistic drops would only be accurate at a specific magnification or the viewing optic (30) would need a means to accurately track the magnification of the magnified optic (31).

In another embodiment, the disclosure relates to a viewing optic with an optical system disclosed herein mounted in front of a traditional magnified riflescope (28) but mounted to a pivoting mount. When in front of the traditional magnified riflescope (28), the viewing optic (16) would provide a ballistic hold reticle. When flipped out of the way of the traditional magnified riflescope (28), the viewing optic (16) would serve as an offset 1× sight and its ballistic hold reticle of the viewing optic (16) would change to a bolder, easier to acquire, reticle, including but not limited to a dot reticle.

In another embodiment, the viewing optic disclosed herein could have a digitally projected reticle or displayed information or current mode of operation based on the current hardware configuration. Modes could include, but are not limited to, reticle size, shape, location, color, or brightness; ability to access/utilize an additional feature such as a laser, illuminator, imager, wireless communication, compass, or another enabler; drawing or removal of ballistic drops; and low or high-power state. While useful for a 1× viewing optic capable of displaying alphanumeric information and/or ballistic drops, this embodiment also has implication for more traditional 1× sights such as red dots and holographic sights. Attachable/detachable enablers that determine/influence the mode/setting could be used or the enablers can be integrated into the viewing optic disclosed herein.

In one embodiment, the viewing optic with an optical system disclosed herein (16) has a LRF (20) and a magnifier (19). This is demonstrated in FIG. 8. In one embodiment, the microdisplay of the viewing optic can generate a first reticle when the magnifier is in position for use and a second reticle when the magnifier is not in position for use.

In one embodiment, when the magnifier (19) is in position for use behind the viewing optic, the microdisplay of the viewing optic (16) displays a refined aimpoint reticle (33b) and the LRF (20) can be enabled. This is demonstrated by FIG. 9. The user can then range targets (32) and have the range to the target (34) and a ballistic hold reticle (33c) generated by the microdisplay and displayed based on the range and the weapon ballistics (see FIG. 19).

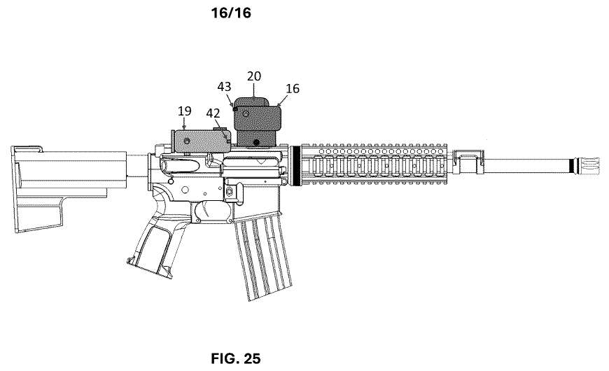

When the magnifier (19) is not being used, the viewing optic (16) digitally projected reticle (33) is a large dot reticle (33a) and the LRF (20) is disabled to minimize distractions. This is represented in FIG. 6. FIG. 25 provides a representative non-limiting example when the magnifier is flipped to the side and out of the way with the viewing optic (16).

Turning back to FIG. 8, the viewing optic (16) may have a detection system to sense when the magnifier (19) is in position for use. In one embodiment, the detection system can be a magnet (42) and a sensor (43). However, the magnifier being in position for use can be detected through multiple means including but not limited to an electrical connection, a short-range wireless signal, an optical sensor, a light sensor, the depressing of a physical switch, or via another appropriate method.

In one embodiment, the magnifier may have a first configuration located behind the viewing optic (position for use) and a second configuration located to the side of the viewing optic (position of non-use). The viewing optic disclosed herein can have a sensor configured to determine the configuration of the magnifier. When the first configuration of the magnifier is detected, the microdisplay of the viewing optic can generates a first digital reticle, including but not limited to a ballistic hold reticle. When the second configuration of the magnifier is detected, the microdisplay of the viewing optic generates a second digital reticle, including but not limited to a large dot reticle or close quarter battle reticle.

In one embodiment, the magnifier (19) may be on a flip up style mount (44) as shown in FIG. 8. The magnifier may be removable from the weapon or rail, or it could be attached and detached through another means.

In another embodiment, when the viewing optic (16) does not have a LRF (20), the viewing optic (16) can automatically display ballistic drops at predetermined intervals as appropriate for the cartridge (such as 100 yds/m for supersonic loads or 50 yds/m for subsonic loads) when the magnifier (19) was in position behind the viewing optic (16).

In one embodiment, the magnifier (19) could be any magnification or any optical design. In another embodiment, the magnifier (19) could also enable cant correction.

In another embodiment, the disclosure relates to a viewing optic with an optical system disclosed herein and an imaging enabler. When an imaging enabler is not being used, the viewing optic functions as a traditional optic. When an imaging enabler is in place, or turned on, a video feed from the imaging enabler is sent to another external device. An example of this embodiment could be a video feed sent via Intra Solider Wireless (ISW) to a wearable headset for Rapid Target Acquisition (RTA).

In one embodiment, the video feed could be through a wired connection or a wireless interface such as ISW, Bluetooth, or another wireless signal style. The communication hardware, such as the wireless transceiver, could be in the viewing optic or an imaging enabler. An imaging enabler could have a solid back to minimize space, or it could have a display in the rear for the user to look at.

In another embodiment, the viewing optic can accept different types of enablers and switch settings/modes depending on which enabler is used. An example would be having both an imaging enabler and a magnifier. Whenever one of the two enablers was in position, the viewing optic could adapt to the enabler.

In an extension of this embodiment, the flip up style mount (44) could have multiple positions. Users could choose to leave the viewing optic in the default configuration or rotate in multiple types of enablers. An example being one position of the flip up style mount (44) could be the magnifier and another could be a rear mounted imaging enabler.

In another embodiment, the disclosure relates to a viewing optic with an optical system disclosed herein or a traditional viewing optic and an illuminator. When the illuminator is activated, the reticle brightness increases to accommodate for the increased brightness of the image scene. The brightness increase may or may not be user selectable. In another embodiment, a laser can also be used with the viewing optic and the illuminator where a laser override could automatically increase the reticle brightness.

In another embodiment, the disclosure relates to a viewing optic with an optical system disclosed herein or a traditional viewing optic and a rear mounted imaging enabler such as a Night Vision Goggle (NVG) monocular or similar device. When the rear mounted imaging enabler is behind the optic, the reticle brightness decreases to an appropriate brightness setting. The rear mounted imaging enabler can be on a flip up style mount, be removable from the weapon or rail, or it could be attached and detached through another means.

In another embodiment, the viewing optic could decrease brightness when in proximity to a non-weapon mounted NVG (such as a set worn over a user's eyes). When a powered NVG was in the appropriate proximity to look through the viewing optic, the sight would automatically dim to an NVG level. The communication to inform the viewing optic that the NVGs were in position could be a short-range wireless signal, a magnet and a sensor, a directional light and light sensor or another appropriate method.

In another embodiment, the disclosure relates to a viewing optic with an optical system disclosed herein or a traditional viewing optic and a Sunshade, Laser Filtration Unit, or another device that has the effect of dimming the image scene. When installed, the viewing optic dims the reticle to increase the runtime and/or display life. The imaging dimming device could be threaded into the sight, clamped on, flipped into place, or installed in another manner.

In one embodiment, the viewing optic disclosed herein could mount to picatinny rails, optics rails, optics mounts, proprietary optics plates, or via any other effective way of mounting to a weapon. Likewise, the viewing optic may use any number or style of clamps, screws, or other hardware to secure itself to a weapon or mount. The viewing optic may also be integral with the weapon. The viewing optic may use existing optical, accessory, or hardware footprints to attach to weapons.

In another embodiment a front rail mounted clip-on imager (23), with a camera and a display, could be paired with the viewing optic (16). The front rail mounted clip-on imager (23) and the viewing optic (16) could communicate via a wired or wireless connection. When the front rail mounted clip-on imager (23) is digitally zoomed, the viewing optic (16) could alter the ballistic hold reticle (33c), or any other displayed information, to compensate or correct for or match the now magnified image scene allowing the ballistic hold reticle (33c) to remain accurate.

The front rail mounted clip-on imager (23) is a representative of a front mounted camera with a display that can feed a full or partial image to the viewing optic (16). This embodiment could be used with a camera imager that mounts to the weapon or viewing optic by any appropriate means and to any appropriate location.

The viewing optic, optical systems and systems disclosed herein are further described, but not limited, by the following paragraphs:

1. An optical system substantially as shown and described herein.

2. An optical system comprising a prism and a microdisplay substantially as shown and described herein.

3. An optical system comprising a doublet prism having a primary prism and a corrective prism and a microdisplay substantially as shown and described herein.

4. A viewing optic comprising a doublet prism comprising a primary prism and a corrective prism and a microdisplay configured to generate an image, wherein the image is directed to the primary prism.

5. A viewing optic comprising: a doublet prism comprising a primary prism and a corrective prism and a microdisplay configured to generate an image, the primary prism configured to receive the image from the microdisplay and the corrective prism configured to receive an image of an outward scene.

6. A system comprising: a riflescope having a body, an objective assembly coupled to a first end of the body configured to focus a target image from an outward scene to a first focal plane, an ocular assembly coupled to the second end of the body; an erector lens system, and a second focal plane; a red dot sight comprising a doublet prism comprising a primary prism and a corrective prism and a microdisplay configured to generate an image, the red dot sight configured to couple to the objective assembly of the riflescope.

7. A system comprising: a riflescope having a body, an objective assembly coupled to a first end of the body configured to focus a target image from an outward scene to a first focal plane, an ocular assembly coupled to the second end of the body; an erector lens system, and a second focal plane; a viewing optic comprising a doublet prism comprising a primary prism and a corrective prism and a microdisplay configured to generate an image, the viewing optic configured to couple to the objective assembly of the riflescope.

8. A system comprising: a viewing optic having a body, a doublet prism comprising a primary prism and a corrective prism and a microdisplay configured to generate an image; and an imaging enabler coupled to the body of the viewing optic.

9. A system comprising: a viewing optic having a body, a doublet prism comprising a primary prism and a corrective prism and a microdisplay configured to generate an image; and an imaging enabler located in front of or behind the viewing optic.

10. A system comprising: a viewing optic having a body, a doublet prism comprising a primary prism and a corrective prism and a microdisplay configured to generate an image; and an enabler coupled to the body of the viewing optic.

11. A system comprising: a viewing optic having a body, a doublet prism comprising a primary prism and a corrective prism and a microdisplay configured to generate an image; and a magnifier located behind the viewing optic as perceived by a user looking through the magnifier.

12. A viewing optic comprising: a body, a doublet prism comprising a primary prism and a corrective prism, a microdisplay configured to generate a digital reticle, and a sensor for detecting the presence of a magnifier, wherein the microdisplay generates a first digital reticle when the magnifier is not detected and a second digital reticle when the magnifier is detected.

13. A system comprising: a viewing optic having a body, a doublet prism comprising a primary prism and a corrective prism and a microdisplay configured to generate a digital reticle; and a magnifier having a first configuration located behind the viewing optic and a second configuration located to the side of the viewing optic, wherein the viewing optic has a sensor for detecting the first configuration and further wherein the microdisplay generates a first digital reticle when the magnifier is in the first configuration and a second digital reticle when the magnifier is in the second configuration.

14. A system comprising: a viewing optic having a body, a doublet prism comprising a primary prism and a corrective prism and a microdisplay configured to generate an image; and a laser rangefinder coupled to the body of the viewing optic.

15. A viewing optic comprising an optical system of any of paragraphs 1-15.

16. A red dot comprising an optical system of any of paragraphs 1-15.

17. A holographic red dot comprising an optical system of any of paragraphs 1-15.

18. The system of any of paragraphs 1-17, wherein the enabler is selected from the group consisting of: a laser range finder (LRFs), a ballistic calculator, a thermal camera, a day camera, a night vision camera, a wind reader, a stabilizer, a compass, an aiming laser module, a battery pack, and an illuminator.

The following Table provides a list of numerical identifiers and associated components that may be useful in understanding the embodiment disclosed herein.

| Number | Associated Label |
|---|---|
| 1 | Beam splitter prism |
| 2 | Display |
| 3 | Display image |
| 3a | Remaining display image light |
| 3b | Discarded display image light |
| 4 | First primary prism surface |
| 5 | Second primary prism surface |
| 6 | Third primary prism surface |
| 7 | Fourth primary prism surface |
| 8 | Fifth primary prism surface |
| 9 | Rear of the prism |
| 10 | User's eye |
| 11 | Image scene light |
| 11a | remaining image scene light |
| 11b | Discarded image scene light |
| 12 | Face of the corrective prism surface |
| 13 | Second corrective prism surface |
| 14 | Primary prism |
| 15 | Corrective prism |
| 16 | 1x viewing optic |
| 17 | Rifle |
| 18 | Magnified viewing optic |
| 19 | Magnifier |
| 20 | LRF |
| 21 | Imaging enabler |
| 22 | Rear mounted imaging enabler |
| 23 | Front mounted clip-on imager |
| 24 | Small 1x viewing optic |
| 25 | Handgun |
| 26 | Large 1x viewing optic |
| 27 | Machine gun |
| 28 | Traditional magnified riflescope |
| 29 | Weapon rail |
| 30 | Viewing Optic |
| 31 | Magnified optic |
| 32 | Target |
| 33 | Digitally projected reticle |
| 33a | Large dot reticle |
| 33b | Refined aimpoint reticle |
| 33c | Ballistic hold reticle |
| 34 | Range to the target |
| 35 | Outline |
| 36 | Etched reticle |
| 37 | Threaded lock ring |
| 38 | Wireless laser rangefinder |
| 39 | Wireless signal |
| 40 | Weapon mounted LRF enabler |
| 41 | Cable |
| 42 | Magnet |
| 43 | Sensor |
| 44 | Flip up style mount |
| 45 | Lens cap |
| 46 | Optical assembly |
| 47 | Lens shroud |

All publications and patents mentioned in the above specification are herein incorporated by reference. Various modifications and variations of the described compositions and methods of the invention will be apparent to those skilled in the art without departing from the scope and spirit of the invention. One skilled in the art will recognize at once that it would be possible to construct the present invention from a variety of materials and in a variety of different ways. Although the invention has been described in connection with specific preferred embodiments, it should be understood that the invention should not be unduly limited to such specific embodiments. While the preferred embodiments have been described in detail, and shown in the accompanying drawings, it will be evident that various further modification are possible without departing from the scope of the invention as set forth in the appended claims. Indeed, various modifications of the described modes for carrying out the invention which are obvious to those skilled in marksmanship, computers or related fields are intended to be within the scope of the following claims.

What is claimed is:

1. A viewing optic comprising:
an optical prism system comprising:
a primary prism having a first surface, a second surface, a third surface, a fourth surface, and a fifth surface; and
a corrective prism,
wherein the primary prism and the corrective prism are attached at the fifth surface, the fifth surface having a transmission-controlling coating and
a micro display configured to generate an image, wherein light from the image from the microdisplay is split at the fifth surface of the primary prism into a first optical path and a second optical path, wherein light of the first optical path is reflected off the fifth surface of the primary prism to a user's eye, and light of the second optical path travels through the fifth surface of the primary prism.

2. The viewing optic of claim 1, wherein the optical prism system is a free form optical prism system.

3. The viewing optic of claim 1, wherein the second surface of the primary prism has a mirror coating.

4. The viewing optic of claim 3, wherein the third surface of the primary prism is uncoated.

5. The viewing optic of claim 4, wherein the fourth surface of the primary prism has a mirror coating.

6. The viewing optic of claim 1, wherein the image from the microdisplay enters the primary prism and is corrected at the first surface of the primary prism.

7. The viewing optic of claim 6, wherein the image from the microdisplay travels from the first surface of the primary prism to the second surface of the primary prism, the second surface having a mirror coating.

8. The viewing optic of claim 7, wherein the image from the microdisplay travels from the second surface of the primary prism to the third surface of the primary prism, the third surface being uncoated.

9. The viewing optic of claim 8, wherein the image from the microdisplay travels from the third surface of the primary prism to the fourth surface of the primary prism, the fourth surface having a mirror coating.

10. The viewing optic of claim 9, wherein the image from the microdisplay travels from the fourth surface of the primary prism to the fifth surface of the primary prism.

11. The viewing optic of claim 1, wherein light from an outward image scene enters through a first surface of the corrective prism.

12. The viewing optic of claim 11, wherein light from the outward image scene passes from the first surface of the corrective prism to the fifth surface of the primary prism.

13. The viewing optic of claim 12, wherein light from the outward image scene is split at the fifth surface of the primary prism into a first outward image scene optical path and a second outward image scene optical path, wherein light of the first outward image scene optical path passes through the fifth surface of the primary prism to a user's eye, and light of the second outward image scene optical path is reflected off the fifth surface of the primary prism.

14. The viewing optic of claim 11, wherein the first surface of the corrective prism is plano and has an anti-reflective coating.

15. A viewing optic comprising:
an optical prism system comprising:
a primary prism; and
a corrective prism,
wherein the primary prism and the corrective prism are attached at a surface of the primary prism that contains a transmission-controlling coating; and
a micro display configured to generate an image, wherein light from the image from the microdisplay is split at the surface of the primary prism into a first optical path and a second optical path, wherein light of the first optical path is reflected off the surface of the primary prism to a user's eye, and light of the second optical path travels through the surface of the primary prism.

16. The viewing optic of claim 15, wherein the optical prism system is a free form optical prism system.

17. The viewing optic of claim 15, wherein the primary prism comprises at least one surface coated with a mirror coating.

18. The viewing optic of claim 15, wherein the primary prism comprises at least one uncoated surface where the image undergoes total internal reflection.

19. A system comprising the viewing optic of claim 1 and an enabler coupled to the viewing optic.

20. The system of claim 19, wherein the enabler is selected from the group consisting of: a laser range finder (LRFs), an imaging enabler a ballistic calculator, a thermal camera, a day camera, a night vision camera, a wind reader, a stabilizer, a compass, an aiming laser module, a battery pack, and an illuminator.

21. A system comprising the viewing optic of claim 1 and a magnifier.

22. The system of claim 21, wherein the magnifier is configured to have a first configuration and a second configuration, the first configuration being located behind the viewing optic and the second configuration being to a side of the viewing optic.

23. The system of claim 22 further comprising a detection system to sense the configuration of the magnifier.

24. The system of claim 23, wherein the microdisplay of the viewing optic generates a first reticle when the detection system senses the magnifier is in the first configuration and generates a second reticle when the detection system senses the magnifier is in the second configuration.

25. A system comprising: a riflescope having a body, an objective assembly coupled to a first end of the body, an ocular assembly coupled to the second end of the body and the viewing optic of claim 1, wherein the viewing optic is a red dot sight and coupled to the objective assembly of the riflescope.

26. A method of displaying an image comprising:
viewing an image of an outward scene with a viewing optic, the viewing optic comprising an optical prism system having a primary prism and a corrective prism and a microdisplay, wherein the primary prism and the corrective prism are attached at a surface of the primary prism that contains a transmission-controlling coating;
generating an image with the microdisplay; and
passing the image from the microdisplay to the primary prism, wherein the image from the microdisplay is split at the surface of the primary prism of the viewing optic into a first optical path and a second optical path, wherein light of the first optical path is reflected off the surface of the primary prism to a user's eye, and light of the second optical path travels through the surface of the primary prism.

27. The method of claim 26, further comprising passing light from an outward image scene through a first surface of the corrective prism.

28. The method of claim 27, further comprising passing light from the outward image scene from the first surface of the corrective prism to the surface of the primary prism.

29. The method of claim 28, further comprising splitting light from the outward image scene at the surface of the primary prism into a first outward image scene optical path and a second outward image scene optical path, wherein light of the first outward image scene optical path passes through the surface of the primary prism to a user's eye, and light of the second outward image scene optical path is reflected off the surface of the primary prism.
